(19) United States
(12) Patent Application Publication
(10) Pub. No.: US 2008/0284278 A1
(43) Pub. Date: Nov. 20, 2008

(54) Electric Thruster

(76) Inventor: Borbas Miklos, Budapest (HU)

Correspondence Address: Borbas Miklos, 1041 Budapest, Rozsa UTCA 56, X/64, Budapest, 1041, HU

(21) Appl. No.: 12/021,130

(22) Filed: Jan. 28, 2008

Related U.S. Application Data
(63) Continuation of application No. 60/887,128, filed on Jan. 29, 2007.

(51) Int. Cl. H02N 1/00

(52) U.S. Cl. 310/309

(57) ABSTRACT

Electric thrusters for generating thrust using a high voltage power supply and insulated and uninsulated electrodes. The electrodes are connected to opposite poles of a high voltage power supply. In one aspect, an electric thruster comprises a high voltage power supply, a first uninsulated electrode having pointed features, a second electrode within an insulating structure but not in contact with the insulating structure, with the electrodes connected to opposite poles of the high voltage power supply, thereby generating a thrust. The apparatus is configured to maintain a distance between the electrodes. In another aspect, a first set of one insulated and one uninsulated electrode are connected to a first pole of a high voltage power supply, and a second set of one insulated and one uninsulated electrodes are connected to a second pole of the power supply. The electrodes are enclosed in a hermetic enclosure and generate a thrust. In other aspects, the electrodes are arranged radially from a rotation axle to produce rotational movement.

### CROSS REFERENCE TO RELATED APPLICATIONS

This application claims priority to U.S. Provisional Patent Application No. 60/887,128 filed on Jan. 29, 2007.

### BACKGROUND

1. Field

Invention relates to thrusters and in particular to electric thrusters.

2. Related Art

Electrical energy can be converted into motion in various ways, and there are many devices for achieving this. One particular approach is to use two electrodes, a thin electrode attached to the positive pole and a larger flat electrode attached to the negative pole of a power supply. With the electrodes properly arranged, the voltage causes a displacement towards the thin electrode, and as a result the system of two electrodes and a power supply can move in space without the need for an external force.

An example of such a device is described in U.S. Pat. No. 2,949,550. The device converts electrical energy to force, and force to mechanical energy, thereby causing the apparatus to move. An advantage of such a device is that for the conversion of energy from one form to another, there is little or no friction and hence the losses are minimal. Such a device can be used as a self-propelling machine, such as for propelling a space craft. In such an application, low size and weight of such a device is of critical importance.

However, such a device has some disadvantages. One is that in the space between the two electrodes there will be an ionization-induced current. The magnitude of this current depends on the size and shape of the electrodes. This disadvantage can be objectionable if the device operates in air or low quality vacuum. Another disadvantage is that the voltage supply used in the device (whose voltage often may exceed several 10 kV's) is not electrically isolated and therefore dangerous when touched by humans or other objects.

It is in general desirable to advance the state of the art of such electromechanical devices, and in particular desirable to remedy the above described disadvantages.

### SUMMARY OF THE INVENTION

Disclosed are embodiments for an electric thruster for generating thrust using a high voltage power supply and insulated and uninsulated electrodes. The electrodes are connected to opposite poles of a high voltage power supply, thereby creating thrust. In one aspect, an electric thruster comprises a high voltage power supply, a first uninsulated electrode having pointed features, a second electrode within an insulating structure but not in contact with the insulating structure, with the electrodes connected to opposite poles of the high voltage power supply, thereby generating a thrust. The apparatus is configured to maintain a distance between the electrodes. In another aspect, a first set of one insulated and one uninsulated electrode are connected to a first pole of a high voltage power supply, and a second set of one insulated and one uninsulated electrodes are connected to a second pole of the power supply. The electrodes are enclosed in a hermetic enclosure and generate a thrust. In other aspects, the electrodes are arranged radially from a rotation axle to produce rotational movement. Other embodiments and variations are described as well.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1 and 2 are diagrams illustrating an electric thruster, in accordance with embodiments of the present invention.

FIG. 3 is a diagram illustrating an embodiment of the present invention wherein the insulation is not in direct contact with the second electrode.

FIG. 4 is a diagram illustrating a symmetrical system, in accordance with an embodiment of the present invention.

FIG. 5 is a diagram illustrating an embodiment having a first electrode 1 and a second electrode 2 connected to a power supply 4.

FIG. 6 is a diagram illustrating a rotating system, in accordance with an embodiment of the present invention.

FIGS. 7 and 8 are diagrams illustrating a drive of a spacecraft or aircraft, in accordance with embodiments of the present invention.

FIGS. 9a, 9b and 9c illustrate hermetically enclosed electric thrusters, in accordance with embodiments of the present invention.

FIGS. 10a and 10b illustrate hermetically enclosed electric thrusters producing rotational movement, in accordance with embodiments of the present invention.

FIG. 11 illustrates another hermetically enclosed electric thruster producing linear movement, in accordance with an embodiment of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Disclosed are embodiments for an electric thruster for creating thrust using electricity. The present embodiments use an insulated or uninsulated conductor as a first electrode (or a plurality of first electrodes) and an insulated conductor as a second electrode (or a plurality of second electrodes). The electrodes are connected to opposite poles of a power supply, thereby creating thrust acting in the direction of the first electrode.

In the following described embodiments, reference is made to a first electrode (or a plurality of first electrodes) and a second electrode (or a plurality of second electrodes). Throughout the description, the first electrode comprises a conductor. One particular arrangement that has been found to work well is when the first electrode comprises a conductor with one or more sharp, thin or pointed features. One such example comprises a conductor spreading out into a plurality of strands at one end, such as a speaker cable with spread out individual wires or wire groups at the end of the cable. Another example comprises an elongated conductor with an edge. Another example comprises a thin wire. Another example comprises a pointed conductor, such as a nail, needle, or other approximately cylindrical conductor with a pointed end. Another example comprises a surface with one or more sharp edges and/or protruding features. In the disclosed embodiments, the first electrode is uninsulated.

The second electrode comprises a conductor substantially enclosed within an insulating structure, such as a cylinder, a sphere, a cone, or any other enclosure. The second electrode may comprise a conducting wire, a conducting surface, or any other conducting structure. In one embodiment, the second electrode comprises a conductor spreading out into a plurality of strands, such as a speaker cable with spread out individual wires or wire groups at the end of the cable, an elongated conductor with an edge, a thin wire, a pointed conductor such as a nail or an approximately cylindrical conductor with a pointed end, a surface with one or more sharp edges and/or protruding features, or other similar structure. In another embodiment, the surface of the second electrode may be flat or curved, for example comprising a flat or curved surface wherein the edges of the surface are rounded off so as not to be sharp or pointed.

One embodiment of the present invention is an electric thruster comprising two electrodes. The electrodes are connected to a high-voltage power supply and kept separate so as not to move towards each other as a result of any attractive force between them. For example, a non-conducting element may be used as a spacer to hold the first and second electrodes apart.

In both above described embodiments, a force (or thrust) acts in the direction of the first electrode (or the in the direction of the plurality of first electrodes in an embodiment that uses a plurality of first electrodes) and causes the device to move in the general direction of the first electrode (or in the direction of the plurality of first electrodes).

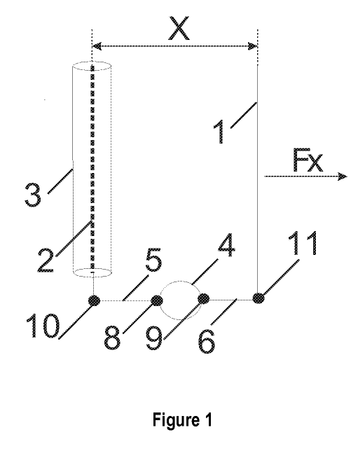

FIG. 1 is a diagram illustrating an electric thruster, in accordance with an embodiment of the present invention. The second electrode 2 is in proximity to the first electrode 1. As described above, the first electrode comprises a conductor with one or more sharp or thin features. In an example embodiment wherein the first electrode 1 is a thin wire, its thickness can vary from a technologically feasible minimum to a few millimeters. By way of example, a 0.15 mm thick copper wire can be used, comprising a thin layer of lacquer insulation. The effect of the insulation on such a wire is insignificant, since at high voltages such wires can be considered uninsulated. Optionally, the insulation may be omitted without significantly affecting the operation and effects of the electric thruster. The second electrode 2 comprises a wire surrounded by insulation 3. By way of example, the insulation 3 can be a piece of Polyvinyl Chloride (PVC) with a thickness of about 1 mm. Optionally, the insulation may be thicker, and its thickness cab be based on the applied electrical voltage. The thickness of the insulation may vary, depending on the quality of the material used. Materials with higher dielectric constants may warrant thinner insulation, hence decreasing the overall weight of the device. Optionally, the diameter of the second 2 electrode is greater than the diameter of the first electrode 1, and it is possible to achieve greater force (thrust) Fx if the diameter of the second 2 electrode is larger. However, even when the diameters of the first 1 and the second electrodes 2 are approximately equal, a force Fx can develop. As described above, it is also possible to use an insulated surface instead of an insulated wire.

In the Figures, the distance between the two electrodes is represented by X. The optimum distance generally depends on the electrical voltage applied. By way of example, a distance of X=12 cm has been found to work particularly well at approximately 50 kV. However, the distance between the electrodes can vary. By way of example, the development of force has been observed from a few cm to approximately 30 cm. However, at a given voltage the force increases with increasing distance X until the force reaches an optimal value, and from that point the force gradually decreases with increasing distance.

If the insulation 3 of the second electrode 2 is of low quality, it will cause ionic currents and will have a diminishing effect on the force. Furthermore, with inferior insulation 3, the losses induced by the ionic currents increase the power consumption of the device.

Electrical junction points 10 and 11 are used to connect the power supply to the 1 and second 2 electrodes. By way of example, a voltage of about 16 kV or greater for the high voltage supply has bee found to work well. The maximum voltage is not limited, and some results have indicated that the force tends to increase with the square of the voltage. Although a force develops with both polarizations of the high voltage supply 4, connecting the first electrode 1 to the positive pole 9 may show a larger force.

The high voltage supply 4 can be direct-current or alternating-current, and the device can be powered by a high voltage transformer as well. The first electrode 1 and the second electrode 2 are connected via the connecting wires 5 and 6 to connection points 10 and 11, to the two poles 8 and 9 of the high voltage supply. Although FIG. 1 diagrammatically shows the first electrode 1 as a thin conductive wire, as described above the first electrode 1 is not limited to that. Furthermore, if a conductive wire is used as the first electrode, the cross section of the first electrode 1 does not have to be circular, but can be of any other shape as long as it has an edge, with the edge considered as the electrode.

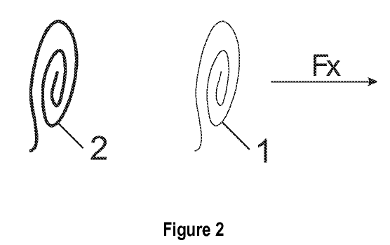

FIG. 2 is a diagram illustrating an electric thruster, in accordance with an embodiment of the present invention. In this embodiment, the second electrode 2 comprises an insulated wire wound up in a spiral. The first electrode 1 is at distance X from the second electrode 2, and is also wound in a spiral. The planes of the windings may or may not be approximately parallel. In fact, a force develops even when the planes are perpendicular. By way of example, 4-5 windings have been found to work well when creating the spirals. In smaller systems more windings will result in greater force. The maximum number of windings is not limited. Instead of wound, the first electrode 1 may comprise a braided wire for an embodiment that achieves greater thrust (not shown in the Figures). By way of example, a distance of X=12 cm between electrodes at 50 kV has been found to work well. A low quality insulation of the second electrode 2 may yield decreased force. Both electrodes are connected to the high voltage supply (not depicted in FIG. 2). A resulting force moves the system towards the first electrode 1. In an embodiment comprising a system suspended from a point (for example with no objects within approximately 1 m of the device), the system swings out upon activation of the power supply and remains in that position as long as power is applied. The power supply can be toggled on and off periodically to cause the system to swing out about the point of suspension.

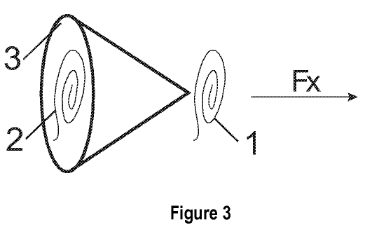

FIG. 3 is a diagram illustrating an embodiment of the present invention wherein the insulation is not in direct contact with the second electrode. In contrast to the previous embodiments, FIG. 3 illustrates a system wherein the second electrode 2 comprises uninsulated wire that is wound into a spiral and surrounded by insulation 3. Insulation 3 is approximately in the shape of a cone and is not in direct contact with the second electrode 2, but rather surrounds the winding 2. The insulation 3 can be spherical, square, rectangular, or any other shape. The insulation 3 encloses the second electrode 2.

The surrounding insulation has a small hole reserved for the connecting wires. This wire connects the high voltage supply to the second electrode 2. A force develops independent of whether the insulation 3 is spherical, square, conical, etc. By way of example, an insulation 3 diameter of about 12 cm at 50 kV has been found to work well. The first electrode 1 is placed outside of insulation 3. Both electrodes are connected to a high voltage supply (not shown in FIG. 3). At both polarizations of the supply a thrust Fx develops in the direction of the first electrode 1.

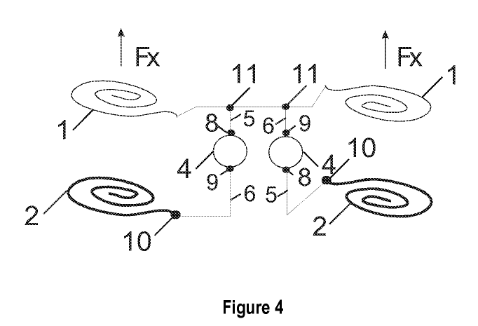

FIG. 4 is a diagram illustrating a symmetrical system, in accordance with an embodiment of the present invention. This symmetrical system represents an electrically shock-resistant design. Two systems with two high voltage supplies 4 are used. The opposite poles of the two high voltages supplies 4 are connected (negative pole 8 of the first and the positive pole 9 of the second power supply, or vice versa) and this is connected to the two first electrodes 1 (comprising uninsulated spiral windings). At connection point 11 they are connected to the 4 high voltage supplies. The other unconnected poles of high voltage supplies 4 are connected to the second electrodes 2 which in the example shown in FIG. 4 comprise insulated spiral windings. They are connected at connection point 10 to the high voltage supplies 4. The developed thrust Fx is in the direction of first electrodes 1. In a shock-proof embodiment, the first (uninsulated) electrodes 1 can be grounded, thereby allowing for the potential of the first (uninsulated) electrodes 1 to be approximately 0V relative to the ground, hence not posing any danger to the touch. The second electrodes 2 are insulated and therefore do not present any danger to the touch either.

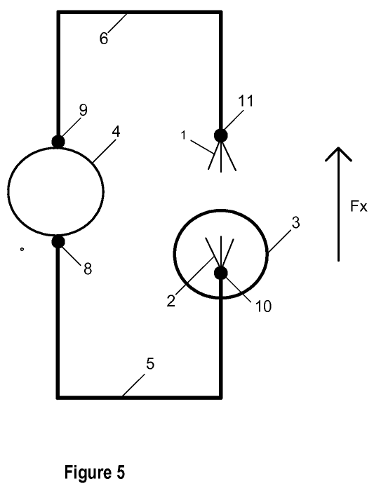

FIG. 5 is a diagram illustrating an embodiment having a first electrode 1 and a second electrode 2 connected to a power supply 4. The second electrode 2 comprises sharp features, as described above, and is enclosed within insulator 3, with the insulation 3 not in direct contact with the second electrode 2. The arrangement shown in FIG. 5 may cause the surrounding air (or other medium) to ionize, and the ionization may diminish the developed thrust. In such a case, optionally a high voltage alternating current power supply may be used in order to prevent ionization buildup.

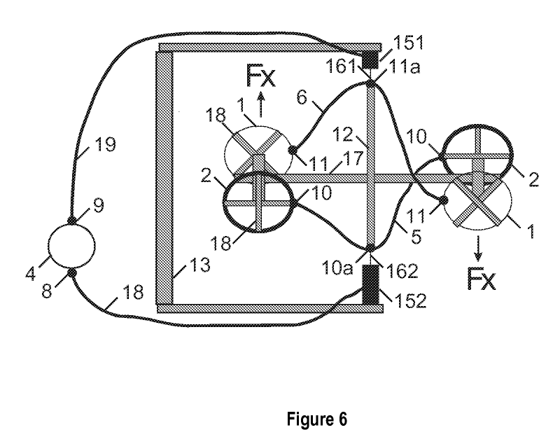

FIG. 6 is a diagram illustrating a rotating system, in accordance with an embodiment of the present invention. The force described in previous embodiments can be converted into a torque if such a rotating configuration is used. The first 1 and second 2 electrodes are mounted by spokes. The spokes are connected to the H-shaped support structure 17 and are connected to axle 12. These connections are preferably rigid. To create a symmetrically rotating system, the torque at axis 17 is preferably identical. The torque is a result of the combined force developed by the two first 1 and two second 2 electrodes and the power supply. The number of systems (first 1 and second 2 electrodes) is not limited to two and can be one or more, but using at least two systems helps creating a balanced rotation. The developed force is tangential to axle 12 and hence results in a torque.

The rotating piece is connected via conductive needles 161 and 162 to the bearings 151 and 152. These bearing are connected to structure 13. The first electrodes 1 are electrically connected via the 6 connection wires to the upper connection point 11a at the needle 161. This needle is electrically connected to the conductor bearing housing 151. This bearing housing is connected via connection wire 19 to the positive pole 9 of the high voltage supply 4. The second electrodes 2 are connected via connection wires 5 to the bottom connection point 10a. This connection point is electrically connected to the needle 162. This needle is electrically connected to the conductor bearing 152. This bearing house is connected via connection wire 20 to the negative pole 8 of the high voltage supply 4.

The system of first and second electrodes creates a force, which in turn is converted into torque, causing the system to rotate in the direction of first electrodes 1. The speed of rotation is limited by air friction and the frictional losses inside the needles 161 and 162 and any energy loss due to ionization currents through the conducting wires. To get greater speed, air friction can be reduced by making the system more aero dynamical, and losses in the conducting wires can be reduced by using high quality insulators. By way of example, an arrangement wherein the first electrodes 1 are made of braided thin wires and the second electrodes 2 are large insulated surfaces has been found to work well.

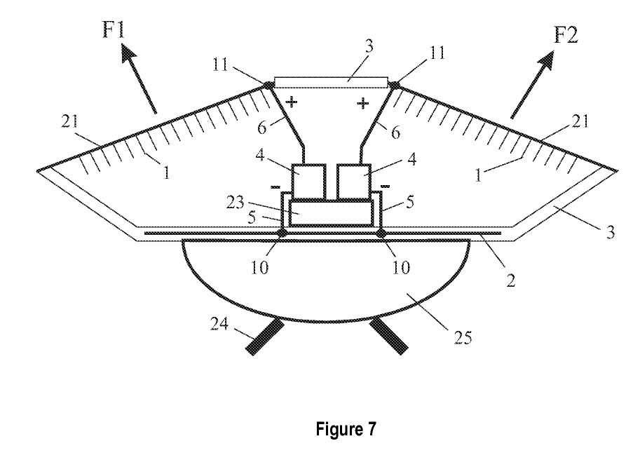

It is contemplated that embodiments of the electric thrusters disclosed herein may be used to power a craft, such as a car, boat, submarine, spacecraft or aircraft. FIG. 7 is a diagram illustrating a drive of a spacecraft or aircraft, in accordance with an embodiment of the present invention. A drive such as an electric thruster described in one of the embodiments herein is placed above compartment 25. This drive is not limited to propelling aircraft or spacecraft, and may be used to drive a submarine or car or other vehicle. In an exemplary embodiment, the aircraft or spacecraft comprises three (or more) separate computer controlled drives which create three separate thrusts F1, F2 and F3 (although it should be noted that any number of separate drives can be used analogously). A system with three drives will allow easy maneuvering. For a submarine using a rudder or similar steering structure, one drive may be sufficient to provide thrust. The same applies to a boat or a car.

The high voltage supplies 4 are powered from one or more batteries 23. The connection wire 5 is connected to the connection point 10 at the second electrode 2, which is common to all drives. The second electrode 2 is inside the insulator 3. On the inner side of the drive unit the first electrodes 1 are approximately perpendicularly mounted onto conductor surfaces 21. The other (positive) poles of the high voltage 4 supplies are connected via connection wire 6 to conductive surfaces 21. Optionally, a high quality vacuum is created inside the drives, since vacuum is a good insulator. Underneath the drives is a compartment 25 which can be used as a crew compartment. When grounded, the spacecraft stands on its feet 24. The forces are most powerful in the direction of the edges of first electrodes 1, and therefore the forces line up with the first electrodes 1. By way of example, the forces have been found to be particularly strong when the first electrodes 1 are mounted perpendicular to the second electrode 2.

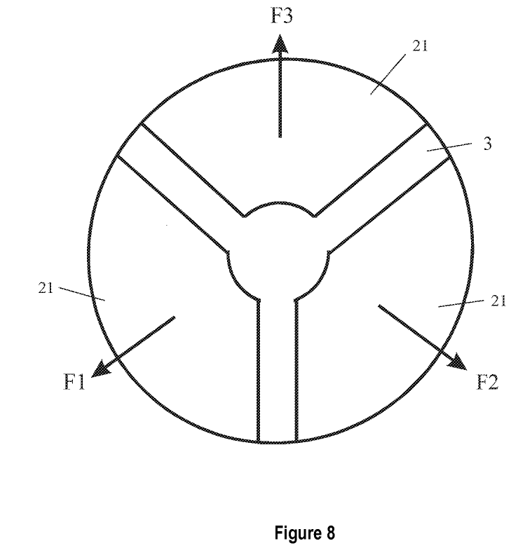

FIG. 8 is a diagram illustrating the top view of a spacecraft or aircraft, in accordance with an embodiment of the present invention. The three conductor surfaces 21 are held together using insulator 3. The insulator 3 is wide enough to prevent electrical discharge between conductive surfaces 21.

The electric thrusters described herein can be used for the propulsion of spacecrafts, satellites, aircrafts, submarines or other such vehicles. It is an advantageous aspect that vehicles propelled by the described electric thrusters would not run out of fuel in the traditional sense since no material is expelled from the systems. For vertically ascending aircrafts, the forces could be made sufficiently large to lift the craft, provided the power supply provides high enough voltages. One advantage of the presently described embodiments is that the electrode which is powered by the high voltage is insulated. This is a matter of technological advancement in power supply design and high quality insulator design.

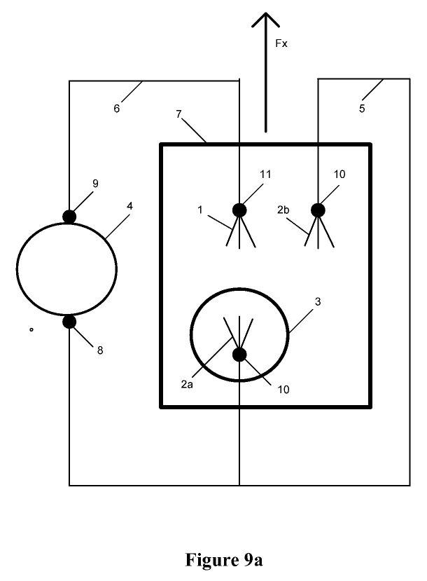

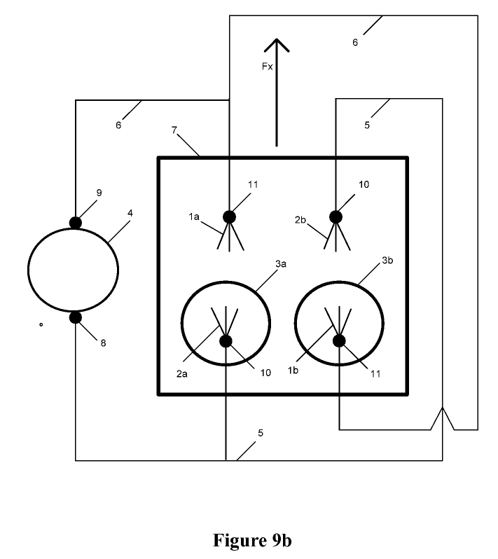

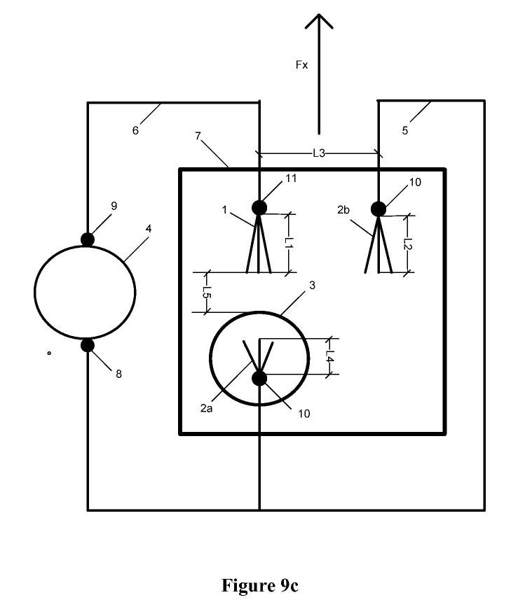

The thrust generated by the embodiment of FIG. 5 can be further increased by hermetically enclosing the first and second electrodes. However, experiments have shown that such hermetic enclosure may be susceptible to ionic buildup in the medium (such as air or other fluid) within the hermetic enclosure, which buildup may over time gradually diminish the total thrust produced. In order to counteract such ionic buildup, the second electrode can be split into two parts, a first part enclosed within an insulator, and a second part that is not enclosed within the insulator and is positioned near the first electrode. Since the second part of the second electrode and the first electrode are oppositely charged, they have a diminishing effect on the ionic buildup. An example of such an embodiment is illustrated in FIG. 9a. As shown in the Figure, the second electrode 2 is split into two parts 2a and 2b (connected by conductor 5), with the first part 2a shown enclosed within insulator 3 and the second part 2b residing outside of insulator 3. Both parts 2b and 2a of the second electrode 2, as well as the first electrode 1, are hermetically enclosed within enclosure 7. Similar to previously described embodiments, the first electrode 1 is connected via conductor 6 to pole 9 of a power supply 4, and the second electrode 2 is connected via conductor 5 to the opposite pole 8 of the direct current power supply 4.

While the embodiment of FIG. 9a addresses the ionic buildup, it introduces an electrical asymmetry within the hermetic enclosure 7. This asymmetry is addressed by splitting the first electrode 1 into two parts 1a and 1b, as shown in FIG. 9b. The first part 1a is uninsulated and the second part 1b is enclosed within insulator 3b. The arrangement of parts 2a and 2b of the second electrode 2 are as described in FIG. 9a, with part 2a enclosed within insulator 3a and part 2b uninsulated. The electrodes are connected as shown to direct current power supply 4. The symmetric splitting of both electrodes in this embodiment more effectively alleviates the ionic buildup. Optionally, for an even more effective alleviation of ionic buildup, a high voltage alternating current power supply 4 can be used.

FIG. 9c illustrates an example implementation of the embodiment shown in FIG. 9a, showing example dimensions that have been found to work particularly well. In this Figure, L1=3.5 cm, L2=3.5 cm, L3=7 cm, L4=1 cm, L5=3 cm, and the power supply 4 produces 25 kV direct current. Optionally, a higher voltage power supply 4 can be used to increase the produced thrust. In that case, L3 and L5 may be increased accordingly, although it is noted that experiments have shown that the increase in shown dimensions are not necessarily linearly related to the voltage increase.

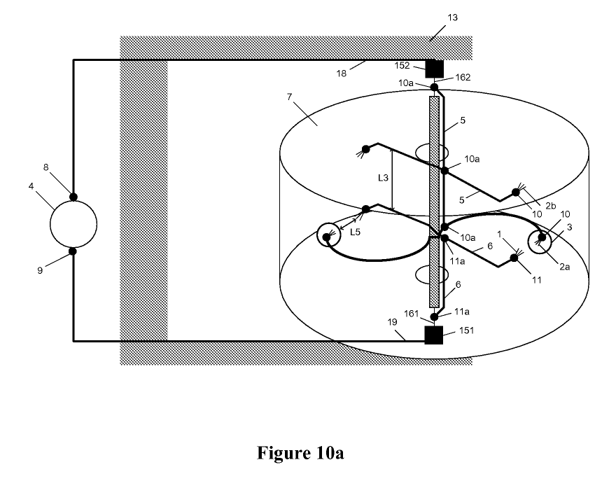

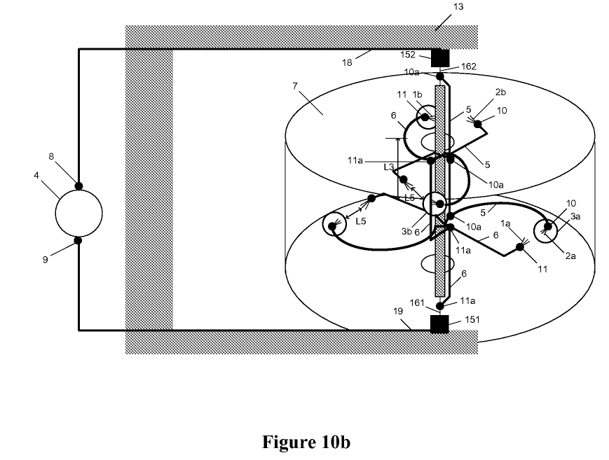

The hermetical embodiment described in FIGS. 9a and 9b can be adapted to convert the produced thrust into rotational movement. Examples of such embodiments are illustrated in FIGS. 10a and 10b, respectively. FIGS. 10a and 10b show embodiments where two sets of electrodes are arranged radially around a rotation axle, each set of electrodes comprising three electrodes as described in FIGS. 9a and 9b, respectively. Note that these embodiments would also work with only one set of electrodes, or with more than two sets of electrodes arranged around the axle.

It is noted that in the hermetically enclosed embodiments, such as the examples illustrated in FIGS. 9a, 9b, 9c, 10a and 10b, the hermetic enclosure 7 can be made of insulating material, or of a grounded conductive material (effectively representing a grounded Faraday cage).

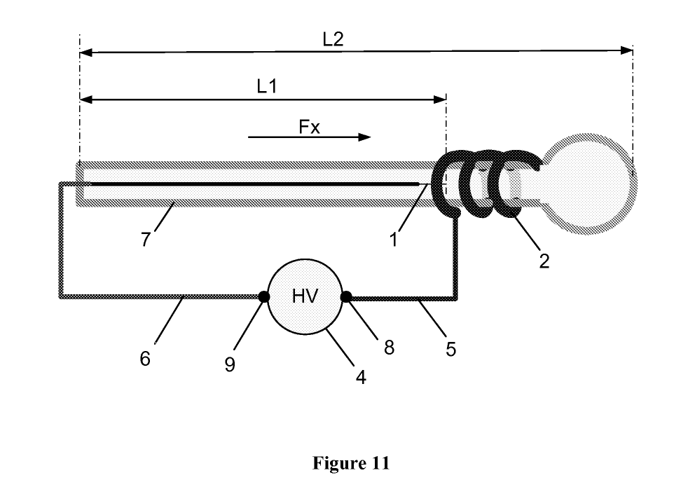

FIG. 11 illustrates another electric thruster, in accordance with another embodiment of the present invention. In this embodiment, the first electrode 1 is within a hermetic elongate hollow enclosure 7 and the second electrode 2 is wound around the outside of the enclosure 7. Within enclosure 7, ions are generated by the electrical field of the first and second electrodes 1 and 2. The enclosure 7 is hermetic and ions cannot leave the enclosure 7. There is no ionic wind generated outside of the enclosure 7. This embodiment generates linear thrust in the direction indicated as “Fx” in FIG. 11. The intensity and direction of the thrust is independent of the polarity of the high voltage power supply 4. In one particular embodiment that has been found to work well, the tubular enclosure 7 has a diameter of approximately 1.2 cm and a length of L2 of approximately 22 cm. The diameter of the first electrode 1 is approximately 1 mm. The second electrode 2 comprises approximately four windings. An optional hollow spherical formation at the end of the enclosure 7, as shown in the Figure, can be used to amplify the thrust.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. The disclosed embodiments may be readily modifiable in arrangement and detail as facilitated by enabling technological advancements without departing from the principals of the present disclosure or the scope of the accompanying claims.

1. An apparatus, comprising:
a high voltage power supply;
a first electrode comprising an uninsulated first conductive material having one or more sharp edges or pointed features;
a second electrode comprising a second conductive material enclosed within an insulating structure, wherein the second electrode is not in contact, with the insulating structure;
the first electrode connected to a first pole of the high power supply, the second electrode connected to a second pole of the high voltage power supply, thereby generating a thrust.

2. The apparatus of claim 1, wherein the first and second electrodes are configured to maintain a distance between them.

3. An apparatus, comprising:
an enclosure;
a first uninsulated electrode in the enclosure, the first uninsulated electrode connected to a first pole of a high voltage power supply;
a first insulated electrode in the enclosure, the first insulated electrode connected to a second pole of the high voltage power supply;
a second uninsulated electrode in the enclosure, the second uninsulated electrode connected to the first insulated electrode;
thereby generating a thrust in a direction from the first insulated electrode towards the first uninsulated electrode.

4. The apparatus of claim 3, further comprising a rotation axle, with the first uninsulated electrode, the first insulated electrode and the second uninsulated electrode are arranged radially around the axle, thereby generating rotational movement.

5. The apparatus of claim 3, further comprising:
a second insulated electrode in the enclosure, the second insulated electrode connect to the first uninsulated electrode.

6. The apparatus of claim 5, further comprising a rotation axle, with the first uninsulated electrode, the first insulated electrode, the second uninsulated electrode and the second insulated electrode are arranged radially around the axle, thereby generating rotational movement.

7. An apparatus, comprising:
a high voltage power supply;
a hermetic elongate hollow structure;
a first electrode comprising an uninsulated first conductive material having one or more sharp edges or pointed features, the first electrode housed within the hollow structure;
a second electrode comprising a second conductive insulated material and wound around the hollow structure;
the first electrode connected to a first pole of the high power supply, the second electrode connected to a second pole of the high voltage power supply, thereby generating a thrust.

8. The apparatus of claim 7, wherein the hollow structure comprises a hollow spherical extension to amplify the thrust.
